(19) United States
(12) Patent Application Publication
(10) Pub. No.: US 2020/0146222 A1
(43) Pub. Date: May 14, 2020

(54) Floating Wetland Structures and Assemblies

(71) Applicant: SEI Manufacturing, Inc., North Augusta, SC (US)

(72) Inventors: Lewis W. Roach, JR., North Augusta, SC (US); Thomas F. Proctor, IV, North Augusta, SC (US)

(21) Appl. No.: 16/682,182

(22) Filed: Nov. 13, 2019

Related U.S. Application Data
(60) Provisional application No. 62/760,082, filed on Nov. 13, 2018.

(51) Int. Cl. A01G 9/02; B63B 35/38

(52) U.S. Cl. CPC A01G 9/028; B63B 2035/4493; B63B 35/38

(57) ABSTRACT

A floating wetland structure designed for placement in a body of water includes: at least one surface module having an upper surface at or above the water level; at least one submerged module below the water level; and a frame interconnecting the surface module and submerged module. The frame maintains the surface module as horizontally offset from the submerged module such that an open water area is defined. The floating wetland structure can have an alternating arrangement of surface modules and submerged modules. The frame may include lengthwise extending members and laterally extending members. Horizontally extending lower members may be interconnected with the upper members by vertically extending members that maintain the submerged module below the water level.

### CROSS-REFERENCE TO RELATED APPLICATION

This application claims the benefit of priority of U.S. provisional patent application No. 62/760,082, titled “Floating Wetland Structures and Assemblies,” filed on Nov. 13, 2018, which is incorporated herein in its entirety by this reference.

### TECHNICAL FIELD

The present disclosure relates to water treatment devices. More particularly, the present disclosure relates to modular floating wetland structures that support biofilm activity.

### BACKGROUND

Man-made floating wetland structures are used to promote biological activities in water to treat waste waters and/or to increase biodiversity. Floating wetlands serve as habitats for microbial life, thus serving to regulate nitrogen and other water contents to promote healthy environmental conditions. Not only do floating wetlands host beneficial biofilms, they also serve as surface thermal barriers that can beneficially adjust water temperatures by absorbing sunlight from above and insulating the host water from heat exchange with surface air.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

According to at least one embodiment, a floating wetland structure is designed for placement in a body of water having a water level. The floating wetland structure includes: at least one surface module having an upper surface at or above the water level; at least one submerged module below the water level; and a frame interconnecting the surface module and submerged module.

The frame can maintain the surface module as horizontally offset from the submerged module such that an open water area is defined.

In one or more example, at least a portion of the floating wetland structure has an alternating arrangement of surface modules and submerged modules.

The frame may include lengthwise extending members and laterally extending members.

The frame may include at least one horizontally extending upper member, at least one horizontally extending lower member, and at least one vertically extending member interconnecting the upper member and lower member.

The frame may include multiple vertically extending members interconnecting the upper member and lower member such that the submerged module is maintained below the water level by the vertically extending members.

The vertically extending members may each have approximately the same length such that the submerged module is maintained in a horizontal disposition below the water level.

The vertically extending members may have different lengths such that the submerged module is maintained in a sloped disposition below the water level.

In at least one example, the plurality of modules comprises multiple layers of buoyant panel material.

One or more surface modules may have upper surfaces with holes for placing plants.

The floating wetland structure may include multiple surface modules and multiple submerged modules, and may define multiple open water areas.

The effective riparian edge of the multiple surface modules is higher than a close-packed arrangement without open water areas.

A biofilm can be supported by the submerged modules. Plant life can also be supported on the submerged modules.

Plant life can be supported by the surface modules.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is a plan view of a floating wetland (FTW) structure, according to at least one embodiment, having surface and submerged modules interconnected by a frame;

FIG. 2 is another plan view of the FTW structure of FIG. 1, with the surface modules shown in dashed lines for illustration of at least portions of the frame;

FIG. 3 is a side view of the FTW structure of FIG. 1, particularly showing frame elements and connections thereof according to at least one embodiment;

FIG. 4A is a perspective view of a partially assembled module, according to at least one embodiment, of the FTW structure of FIG. 1;

FIG. 4B is a perspective view of the module of FIG. 4B further assembled;

FIG. 5 is a prior-art data chart showing vertical profiles of dissolved oxygen in various types of free water surface wetlands;

FIG. 6 is a diagrammatic representation of an FTW structure according to at least one other embodiment;

FIG. 7 is a side view of another embodiment of an FTW structure in which submerged modules are deployed vertically below a horizontally positioned floating surface structure;

FIG. 8 is a plan view of and environmental control FTW structure, according to at least one embodiment, including both surface modules and submerged modules and interstitial open water areas to increase effective riparian edge; and

FIG. 9 is a plan view of a basic FTW structure, according to at least one embodiment, with tight-packed surface modules and no interstitial open water areas.

### DETAILED DESCRIPTIONS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

Most prior-art treatment wetlands are plant-based systems, in which function is related to plant structure. In a departure from plant-based orthodoxy, the implementations described below take a thermodynamic approach to treatment wetland design. Wetland functions are regulated by microbiota and their metabolism. The energy that supports microbial growth and metabolism is generated in redox reactions, a chemical process in which electrons are transferred from electron donors to electron acceptors. Wetland biogeochemical function is a predictable outcome of the interaction between thermodynamic constraints on microbial communities and supplies of electron donors and acceptors. Thermodynamic-focused design is derived from the theoretical, with mechanistic underpinnings, leading to a priori predictions; whereas, plant-based design is derived from empirical data. A thermodynamic-focused treatment wetland design incorporates the scientific foundations of biological control necessary for maximizing the treatment capacity of natural treatment wetland systems.

A thermodynamic approach to treatment wetland design, according to various embodiments within the scope of these descriptions, is implemented by an engineered floating treatment wetland (FTW) platform that incorporates wetland elements having specific traits which can be utilized to affect the redox state of the treatment zone, such as submerged surfaces with variable depth and orientation, open-water areas, surface cover, and high ratios of riparian edge to total treatment area. More oxidizing conditions are predominately obtained by incorporating wetland elements associated with photosynthetic oxygen generation and atmospheric diffusion, such as submerged surfaces and open water areas. More reduced conditions are obtained by using floating wetlands as water surface cover to restrict the amount of oxygen entering the water and varying microbial habitat density. Variable configurations of an FTW platform may also beneficially affect temperature and hydrology in the treatment zone.

Example 1: In a field implementation of thermodynamic-based design, a treatment wetland for treating high-nitrate, nitrified wastewater in a lagoon at a wastewater facility is designed, in at least one embodiment, based on an inflow ranging from 20,000 to 25,000 gallons per day at 60 to 80 mg/l nitrate concentration. The treatment lagoon was sized at 520 m², thus requiring nitrate removal rates >10,000 mg/m²/day for complete reduction of nitrate load, an order of magnitude larger than the upper range of wetland reported denitrification rates at 1020 mg/m²/day. The thermodynamic-focused treatment wetland's size was more than an order of magnitude smaller than conventional plant-based design would suggest. Operating data indicated nitrate reduction rates >10,000 mg/m2/day and complete nitrate reduction as long as biological oxygen demand (electron donors) was maintained at 25 mg/l or greater.

TABLE 1
Data from Example 1

| | INLET | OUTLET | AVERAGE | INLET | OUTLET | NITRATE |
|---|---|---|---|---|---|---|
| | NITRATE | NITRATE | MONTHLY FLOW | BOD | BOD | REMOVAL RATE |
| SAMPLE DATE | mg/l | mg/l | GPD | mg/l | mg/l | mg/m²/day |
| Jun. 26, 2017 | 54 | <0.5 | 23699 | <6 | 150 | 9316 |
| Jul. 10, 2017 | 63 | 5.5 | 22245 | <4 | 16 | 9311 |
| Jul. 31, 2017 | 63 | <0.1 | 22245 | <4 | 54 | 10,201 |
| Aug. 14, 2017 | 72 | <0.1 | 19217 | — | — | 10,072 |
| Jun. 11, 2018 | 68 | <1 | 19,466 | <4 | 27 | 9635 |
| Jun. 27, 2018 | 58 | <0.5 | 19,466 | <4 | 45 | 8239 |
| Jul. 9, 2018 | 61 | 12 | 19,082 | | 12 | 6802 |
| Jul. 26, 2018 | 62 | <1 | 19,082 | <4 | 26 | 8612 |
| Aug. 13, 2018 | 69 | <1 | 17,219 | <4 | 27 | 8649 |

The thermodynamic gradient between more reducing conditions and more oxidizing condition contains a redox zone in which denitrification occurs rapidly and efficiently. The Example 1 data supports the a priori design for that specific thermodynamic zone. As one travels the thermodynamic gradient from more oxidizing to more reducing conditions, the processes involving the use of various electron acceptors during the degradation of organic matter would follow an order from aerobic, to nitrate reduction, manganese reduction, iron reduction, sulfate reduction, and methane reduction. The variations in platform configuration provide incremental adjustments affecting the redox environment providing the ability to create a favorable redox environment for the desired reduction process.

Dissolved oxygen (DO) concentrations vary within a wetland and are affected by depth, shading, biological oxygen demand (BOD), and numerous other factors. Floating treatment wetlands (FTW)s lower dissolved oxygen levels in the waters underneath their footprint by physically blocking sunlight for photosynthetic production of oxygen and blocking diffusion from the atmosphere. DO levels underneath an FTW are reduced by microbial activity related oxygen consumption associated with plant roots. These FTW traits provide a control mechanism for creating more reducing conditions. For creating more oxidizing conditions, wetland elements such as submerged surfaces and open water areas are employed.

Submerged surfaces provide more oxidizing conditions, whereas traditional floating wetlands that cover the surface provide more reducing conditions. In a report on vertical profiles of DO in various types of Free Water Surface (FWS) wetlands, substantial differences were reported in DO concentrations among wetland habitat types, with the lowest DO levels associated with emergent and floating vegetative systems with DO levels of 1-2 mg/l, and the highest DO levels found in submerged systems, with mean levels of 10 mg/l. Open water sites' DO levels were intermediate, with mean DO of 6.0 mg/l. FTWs would be comparable to floating vegetative systems. Oxygen levels associated with submerged surfaces were approximately 5 times higher than floating systems.

Microbial communities associated with submerged surfaces benefit from photosynthetically-generated oxygen being produced within a biofilm. Oxygen supply into and out of a biofilm is a diffusive process, with a DO gradient extending from the bulk water, through a diffusive boundary layer, and into the biofilm, with oxygen moving from high concentration areas to low concentration areas. A shaded (non-illuminated) biofilm would tend to have an oxygen gradient moving from the higher DO levels in the bulk water toward the lower DO levels within the biofilm, resulting in the effective DO concentration available to the microbial community within the biofilm being lower than the DO concentration measured in the bulk water. In a submerged surface biofilm receiving sunlight, oxygen is being produced within the biofilm, and as light intensity increases, the amount of oxygen produced by photosynthesis increases. As light intensity exceeds the compensation point, the point on the light curve where photosynthesis produces an amount of oxygen equal to the oxygen requirements within the biofilm, the biofilm becomes an exporter of oxygen to the bulk waters. In this case, the DO level within the biofilm is higher than measured in the bulk water. In one report, with bulk water oxygen concentration of 200 μmol/l (6.4 mg/l), the oxygen concentration was reduced to zero at 0.02 cm depth in a cyanobacterial mat without irradiance, while that with irradiance of 1000 photons/m²/sec, the oxygen concentration at 0.02 cm deep in the mat rose to approximately 900 μmol/l (28.8 mg/l).

A study in 1996 reporting the effects of light on photosynthesis and photosynthesis-coupled respiration found that areal respiration of an illuminated biofilm was 7.8 times higher at an irradiance of 200 photons/m²/sec than the areal dark respiration. In addition to increased oxygen supply, higher microbial activity was also ascribed to deeper oxygen penetration into the biofilm in light conditions, with an oxygen penetration depth of only 0.2-0.5 mm in the dark and an oxygen penetration depth of 2.0 mm in light.

In an experiment that maintained a minimum DO concentration of 1.1 mg/l in the bulk water, another reported that under light conditions, nitrification rates in an algal-bacterial biofilm were 945 mg-N/m²/day, while under dark conditions nitrification rates were 156 mg-N/m²/day.

Riparian edge is widely recognized as an important ecosystem control point, associated with high-biogeochemical activity rates. Another coined the term “hotspot” in describing the high biogeochemical activity associated with terrestrial-aquatic interfaces, noting that hot spots occur where hydrological flow paths converge with substances or other flow paths containing complementary or missing reactants. The inclusion of open water areas and flow channels in FTW design creates additional riparian edge and provides paths for hydrological flows bringing nutrients/reactants to the reaction site, significantly improving mass transfer relative.

Temperature control strategies—Literature reports that FTWs have modest effect on water temperature. The use of submerged-surface FTWs offers a means to affect temperature, both raising the temperature of the top surface biofilm communities and cooling the water column underneath the submerged body. Nitrification rates begin to decline significantly as temperatures drop below 15 degrees C. The benefit from raising the temperature in the reaction site would apply over the entire cold weather range of the temperature/activity curve, shifting the activity curve upwards by the amount of temperature differential at the reaction site. The placement of submerged surfaces a few cm under the water surface reduces the mass of water being heated, resulting in a greater change in temperature in the reduced water volume. The observed difference between the water temperature over the submerged surface and the bulk water varies as a function of submerged surface total area, wind induced mixing, and other factors. The difference of 1-2 degrees Celsius has a significant effect on activity rates over the 0-15 degrees Celsius range.

The solar heat that would normally enter the water column is “captured” in the top few cm of the water column and the submerged surface body acts to insulate the water column below. The higher temperature on the top surface results in increased amounts energy being removed from the water column via evaporation, resulting in lower temperatures below the submerged surface body.

Various embodiments of floating wet land (FTW) structures are illustrated and described herein. The structures can be deployed at and/or under the surface of a body of water or water way so as to mimic a true wetland. Significant biological activity is promoted over the wetland device during cold weather in which the surrounding waters are lacking in activity. Measurements show that the temperature over such wetland structures can be 5-6 degrees F. higher on a sunny day than the surrounding water. An energy balance around a wetland structure, based on a 300 watts per square meter of solar energy and a 4 inch depth, yields an expected delta temperature of 5.4 degrees F. This phenomenon has been sustainably observed and validated with a mathematical model.

Many small communities utilize lagoon systems for wastewater treatment. Bacterial activity becomes close to zero as temp approaches 0 degrees C., resulting in an inability of these some treatment systems to meet permit discharge limits in cold weather. It is possible that the several degrees that the inventive structures described and illustrated herein can raise temperatures by concentrating solar energy may have significant value in wastewater treatment.

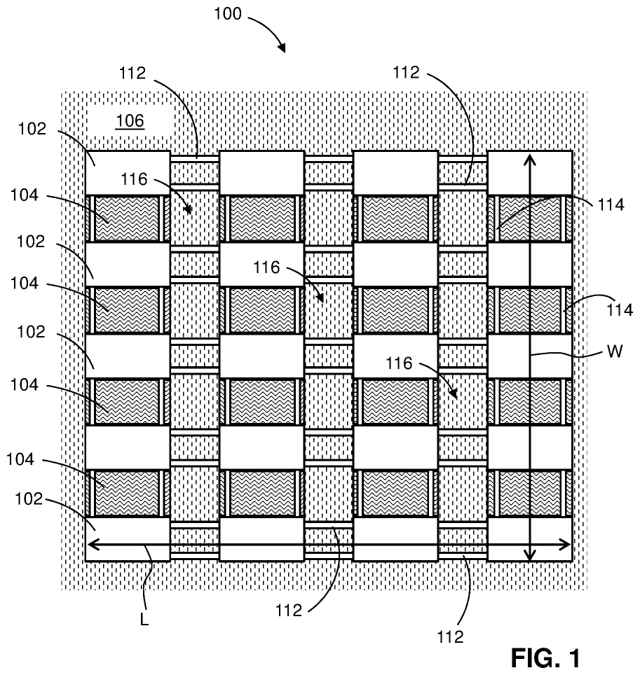

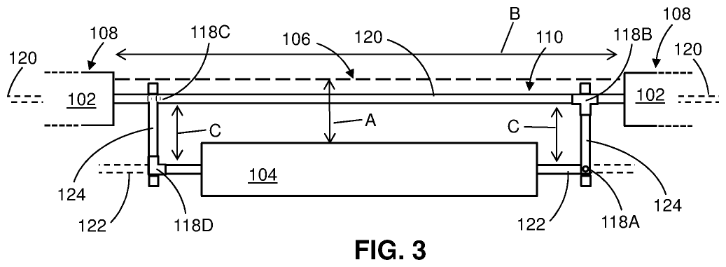

FIG. 1 is a plan view of a floating wetland (FTW) structure 100 according to at least one embodiment. The floating structure 100 includes vertically offset modules, of which the higher modules are described herein as surface modules 102, and the lower modules are described herein as submerged modules 104. The structure 100 as a whole has positive buoyancy such that the submerged modules 104 are below a water level 106 and upper surfaces 108 (FIG. 3) of the surface modules 102 are above the water level 106 when the structure 100 is deployed in a body of water. A structure 100 according to these descriptions can have any number of surface modules 102 and submerged modules 104. Thus the particularly illustrated number and arrangement of modules in FIG. 1 should be taken as a non-limiting example.

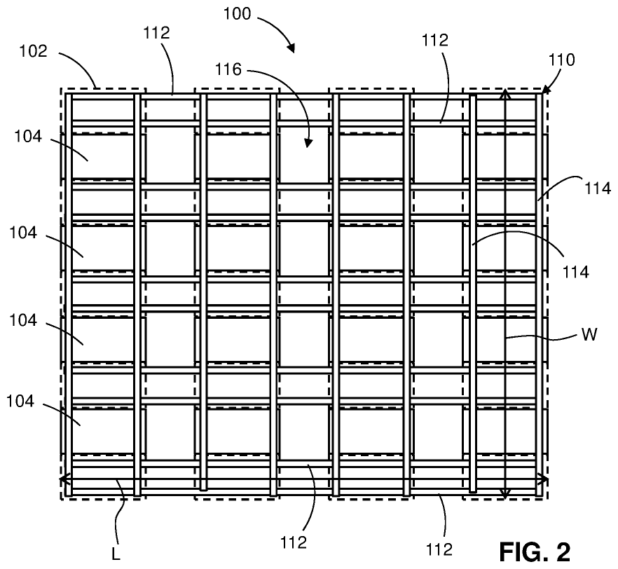

The floating wetland (FTW) structure 100 includes a skeletal frame 110 (FIG. 3) having rigid spacing members extending in two dimensions corresponding to the length L and width W of the structure 100 in the plan view of FIG. 1. Both lengthwise extending (L) first members 112 and laterally extending (W) second members 114 are shown. The surface modules 102 and submerged modules 104 are interconnected by the first members 112 and second members 114 of the frame 110. In at least some embodiments, for example as illustrated in FIGS. 1 and 2, the frame 110 maintains at least some modules as horizontally offset from at least some neighboring modules such that spacings are maintained between the modules along the members to define open water areas 116 in interstitial areas or positions in the FTW footprint (LxW). The first members 112 and second members 114 are illustrated as perpendicular in the drawings. Other arrangements, beyond those particularly illustrated, for the frame 110 in which the first members 112 and second members 114 cross and interconnect at right angles and at oblique angles are within the scope of these descriptions.

FIG. 2 is another plan view of the structure 100, with the surface modules 102 shown as transparent as represented in dashed lines, and without a water level shown, for illustration of at least portions of the frame 110.

FIG. 3 is a side view of the structure 100, showing elements of the frame 110 according to at least one embodiment. The upper horizontally extending member 120 can represent either a first member 112 or a second member 114 in various embodiments. A lower horizontally extending member 122 is shown as submerged below the water level 106 thus maintaining the submerged module 104 at a vertical position relatively lower than the surface modules 102 according to the vertical length C of the vertically extending members 124 by which the lower member 122 is connected to the upper member 120. The vertical length C of each vertically extending member 124 may be the same so as to arrange the submerged module 104 in a horizontal plane parallel to the surface modules 102 and generally rectangular configuration of the structure 100. In other embodiments, the vertical length C of the vertically extending members 124 may vary so as to lean or slope the submerged module 104 at any angle preferred according to a particular installation or use. By selection of the vertical length C, a distance A by which the upper surface of the submerged module 104 is submerged below the water level 106 is set. The distance B is the distance of open water receiving sunlight and atmospheric diffusion between the surface modules 102 and above the submerged module 104 in the illustrated example.

The vertically extending members 124 can be connected to the upper horizontally extending members 120 and lower members 122 by way of various connection types as represented in FIG. 3. Non-limiting examples for connection types include: a fastener connection 118A using a fastener such as a bolt, screw or rivet; a jointed connection 118B using T-joint or joint connector; a welded joint 118C; and a connection 118D using a right-angle channel or bracket.

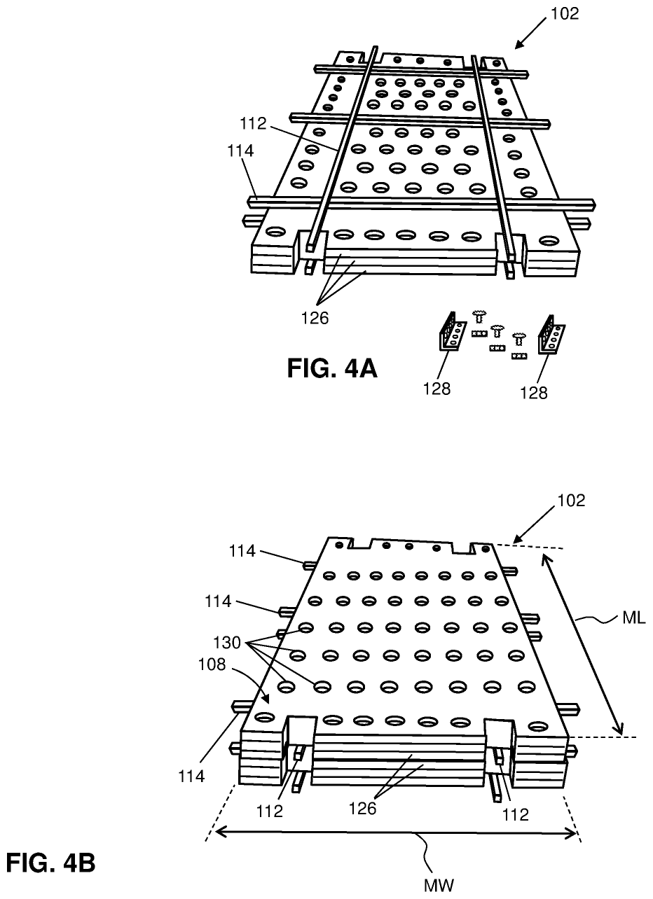

FIG. 4A is a perspective view of module components according to at least one embodiment. A module can be constructed using multiple layers 126 of buoyant panel material as shown, with first members 112 and second members 114 placed above, below, or integrated between the layers. Interconnecting hardware for splicing together adjacent modules and/or members is shown to include, as non-limiting examples, L-channel splice members 128 and paired bolt and nut pairs. By these illustrated connectors, or other types of connectors or connections within the scope of these descriptions, any number of modules can be assembled together as a floating wetland (FTW) structure 100 extending in two dimensions to meet any desired size with regard to length L and width W (FIG. 1) and having any arrangement of surface modules 102 and submerged modules 104 as staggered, alternating, spaced, or otherwise.

The frame members 112 and 114, in both upper and lower horizontally extending examples as represented in FIG. 3, and the vertically extending members 124, can be fabricated of metal or other materials. For example, each can be fabricated of square aluminum tubing. The modules can be constructed of layers of synthetic or plant-based, porous plant root media and closed-cell polyurethane foam, which can be variably configured to accommodate the desired plant and buoyancy specifications. Some of these materials are available in mat form in a variety of thicknesses for selection according to the thickness and dimensions desired for a module, which can be layered as shown in FIGS. 4A and 4B. The frame members can be embedded in modules. Black foam material can be used, for a top layer at least for example with reference to the upper surface 108 of surface module 102, for higher sunlight absorption and thermal response to sunlight relative to lighter colored materials which may reflect relatively more light.

The multiple layers 126 can be laminated together. The module shown in partial assembly in FIGS. 4A and 4B is referenced as a surface module 102. A submerged module 104 can be similarly constructed. Modules 102 and 104, and layers thereof, can be adhered to the frame 110 by, for example, buoyant polyurethane foam adding buoyancy and filling gaps and spaces as well. Foam blocks, for example of the same or similar material of which the layers 126 are made, may be included to fill interlayer spaces that may occur for example between frame members.

A constructed module 102 is shown in FIG. 4B as a non-limiting example in which some of the first members 112 and second members 114 extend between the layers of the module. The upper surface 108 is shown as having holes 130 in which plants can be planted and grown or otherwise promoting biological activity on the surface module to better provide a surface habitat. The holes 130 can be of any selected depth according to desired function and plant species. The holes 130 can be regularly and selectively spaced according to plant needs.

While other dimensions and shapes are within the scope of these descriptions, in at least one non-limiting example according to FIG. 4B, A surface module 102 is rectangular and is dimensioned as five feet (module width, MW) by eight feet (module length, ML). A submerged module 104 can be same or similarly dimensioned.

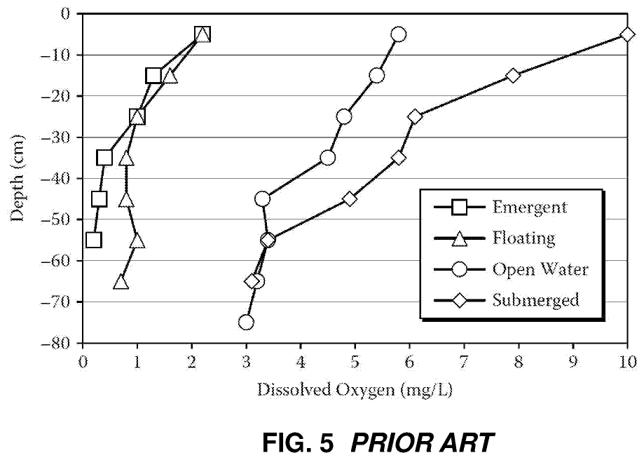

FIG. 5 is a prior-art data chart showing vertical profiles of dissolved oxygen in various types of FWS (Free Water Surface) wetlands, Florida. Data was from 141 profiles collected over a 2½ year period. Data from Chimney et al. (2006), Figure from Kadlec & Wallace (2009).

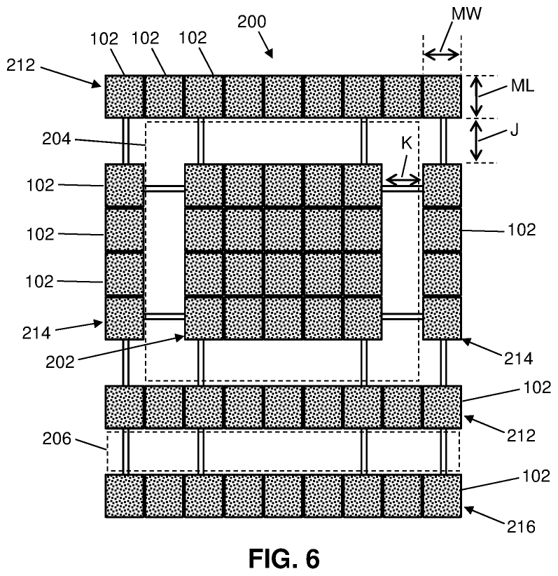

FIG. 6 is a diagrammatic representation of an FTW structure 200 according to at least one embodiment. The FTW structure 200, having similarities and differences in comparison to the FTW structure 100 of FIG. 1, represents a non-limiting example of a structure that can be fabricated by interconnecting surface modules 102 to form a larger assembly. A central core FTW assembly 202 of closely packed modules 102 is shown as surrounded by an open water area 204. The FTW structure 200 thus has a core FTW assembly 202 and alternating open water-FTW areas, such as open water area 206. FTWs have been shown to significantly reduce the dissolved oxygen (DO) beneath their physical footprint, and also promote anoxic conditions in adjacent open water areas, increasing the extent of favorable conditions for denitrification. It has been further reported that these DO effects were related to the FTW size and the ratio of the water body covered by the FTW.

Mutually perpendicular dimensions J and K, as measured in FIG. 6 between spaced edges of the surface modules 102 across open water spaces, define the dimensions of the open water areas in the FTW structure 200 of FIG. 6. J and K can be variably determined by an oxygen control model. The central core FTW assembly 202 establishes an anoxic zone. The outer assemblies 212, 214 and 216 of closely packed surface modules 102 divide what would otherwise be larger open water areas into smaller areas, such as open water area 206.

While other dimension are within the scope of these descriptions, in at least one non-limiting example of an FTW structure 200 according to FIG. 6, the surface modules 102 are dimensioned as six feet (module width, MW) by six feet (module length, ML), and the dimensions of the open water areas are defined by the dimensions J as six feet and K as six feet.

Strategically positioned FTWs can divide open water into smaller units such that the core wetland become more dominant relative to any one area of open water; and the core wetland's anoxic zone can be projected beyond its own footprint and extend across small strips of open water, expanding the treatment zone. The frame work accomplishes the task of creating an anoxic treatment zone while maintaining a restricted oxygen input into the system.

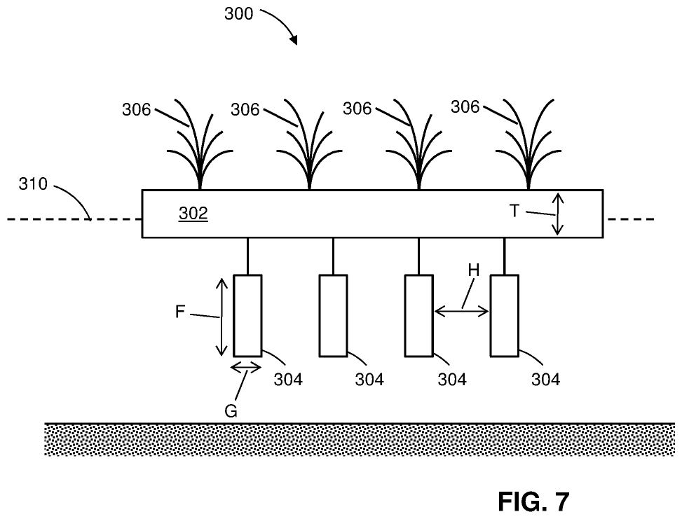

FIG. 7 shows another embodiment of an FTW structure 300 in which submerged modules 304 are deployed vertically below a horizontally positioned floating surface structure 302 at the water level 310. The floating surface structure 302 provides a surface habitat for plants 306 in the illustrated embodiment, and the submerged modules 304 may provide microbial life habitat. The dimensions of the components of the FTW structure 300, including the height F and diameter G of the submerged modules 304, and the distance H between the submerged modules 304 can be varied according to needed performance. The thickness T of the surface structure 302 can be similarly selected, for example to provide sufficient buoyancy to the structure 300 overall.

Microbial communities associated with submerged surfaces benefit from photosynthetically-generated oxygen being produced within the biofilm. Oxygen supply into and out of a biofilm is a diffusive process, with a DO gradient extending from the bulk water, through a diffusive boundary layer, and into the biofilm, with oxygen moving from high concentration areas to low concentration areas. A shaded (non-illuminated) biofilm would tend to have an oxygen gradient moving from the higher DO levels in the bulk water toward the lower DO levels within the biofilm, resulting in the effective DO concentration available to the microbial community within the biofilm being lower than the DO concentration measured in the bulk water. In a submerged surface biofilm receiving sunlight, oxygen is being produced within the biofilm, and as light intensity increases, the amount of oxygen produced by photosynthesis increases. As light intensity exceeds the compensation point, the point on the light curve where photosynthesis produces an amount of oxygen equal to the oxygen requirements within the biofilm, the biofilm becomes an exporter of oxygen to the bulk waters. In this case, the DO level within the biofilm is higher than measured in the bulk water. Another reported that with bulk water oxygen concentration of 200 μmol/l (6.4 mg/l), the oxygen concentration was reduced to zero at 0.02 cm depth in a cyanobacterial mat without irradiance, while that with irradiance of 1000 photons/m²/sec, the oxygen concentration at 0.02 cm deep in the mat rose to approximately 900 μmol/l (28.8 mg/l). The oxygen level within the biofilm was 4.5 times greater than the bulk water.

A natural riparian edge is the interface between land and a body of water. An FTW contributes additional man-made riparian edge when deployed in a body of water. Riparian edge is an important ecosystem control point, associated with high activity rates. The term “hotspot” is used to describe the high biogeochemical activity associated with terrestrial-aquatic interfaces, noting that hot spots occur where hydrological flowpaths converge with substances or other flowpaths containing complementary or missing reactants. The inclusion of open water areas and flow channels in FTW design creates additional riparian edge and provides paths for hydrological flows bringing nutrients/reactants to the reaction site, significantly improving mass transfer relative to conventional FTW design.

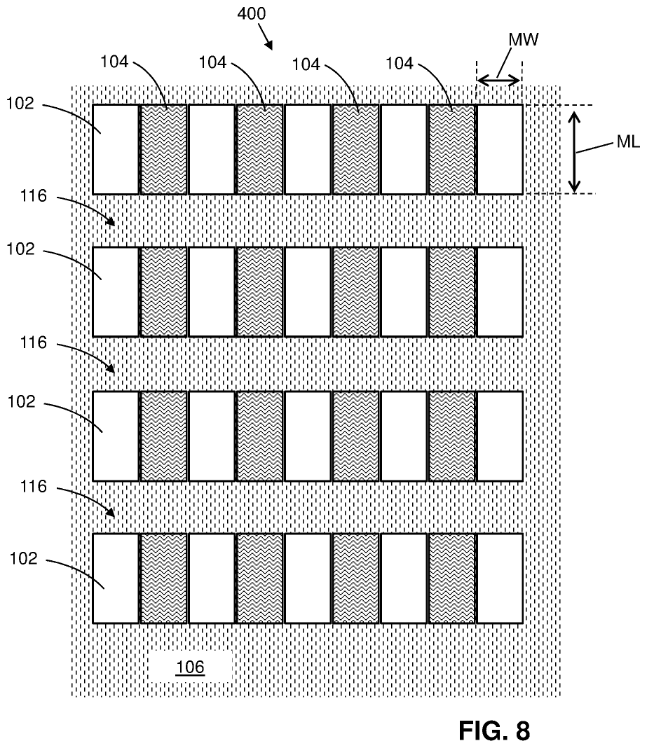

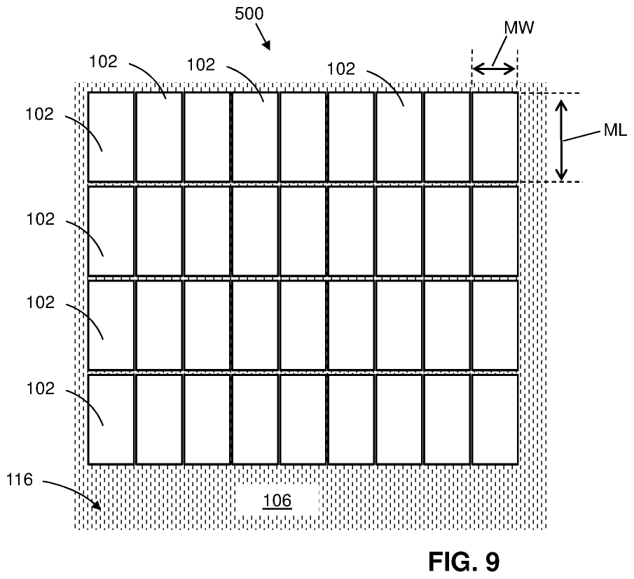

Examples of implementing multiple wetland habitats design strategies to regulate oxygen levels are illustrated in the contrasting close-packed FTW structure 400 of FIG. 8 and FTW structure 500 of FIG. 9 in which open water areas 116 are defined. Each example is made up of thirty-six modules, each module having dimensions of five feet (MW) by eight feet (ML). Thus, each structure 400 and 500 has a totaling module area of 1440 square feet. The basic FTW structure 500 in FIG. 9 includes thirty-six surface modules 102 connected in a tight-packed contiguous manner and rectangular grid arrangement. The environmental control FTW structure 400 in FIG. 9 includes twenty surface modules 102, sixteen submerged modules 104, and a skeletal metal frame having rigid spacing members (see first members 112 and second members 114 in FIGS. 1-2 for illustration of spacing members) facilitating the inclusion of open water areas and flow channels throughout the entire FTW footprint, thus expanding the effective FTW footprint to 2115 square feet using five foot long spacer bars spanning the open water areas. The environmental control FTW structure 400 of FIG. 8 has 520 linear feet of riparian edge compared to 154 feet for the basic FTW structure 500 of FIG. 9. Thus, the riparian edge of the FTW structure 400 is increased by 237% relative to that of the close-packed basic FTW structure 500 by inclusion of spacings between modules defining open water areas 116 in interstitial areas or positions in the FTW footprint. These riparian edge values are calculated by summing the periphery dimension (26 feet for a 5 foot by 8 foot module) of the total number of surface modules 102.

For illustration purposes, the sections of FIGS. 8 and 9 are similarly pattern coded to identify surface modules 102 (FIGS. 8 and 9), submerged modules 104 (FIG. 8), and open water areas 116. Each of these three types of environment is associated with DO level, such that a DO profile map can be ascertained for the structures 400 and 500 in view of FIGS. 8 and 9.

The basic FTW structure 500 in FIG. 9 has 1440 square feet of floating area (surface modules 102) associated with 1-2 mg/l DO levels. The environmental control FTW structure 400 of FIG. 8 has 800 square feet of floating area (surface modules 102) associated with 1-2 mg/l DO levels, 640 square feet of submerged area (submerged modules 104) associated with 8-10 mg/l DO levels, and 675 square feet of open water areas 116 associated with 5-6 mg/l DO levels. These DO levels are offered as a relative comparison and may not be quantitatively accurate to every implementation, as FTW effects on DO are related to both FTW size and water body size. The open water areas and submerged areas in FIG. 8 not only increase the overall DO profile of the FTW, but they also provide enhanced mass transfer.

The above-described embodiments and those inferred in view of these descriptions and referenced drawings are beneficial for water treatment, for example by promoting biofilm activity on submerged surfaces where photosynthetically-generated oxygen is produced by biofilm microbial life.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A floating wetland structure for placement in a body of water having a water level, the floating wetland structure comprising:
a frame; and
a plurality of modules comprising:
at least one surface module having an upper surface for placement at or above the water level; and
at least one submerged module for placement below the water level.

2. The floating wetland structure according to claim 1, wherein the frame maintains at least two modules of the plurality of modules as horizontally offset from each other such that a spacing are maintained to define an open water area.

3. The floating wetland structure according to claim 1, wherein at least a portion of the plurality of modules has an alternating arrangement of surface modules and submerged modules.

4. The floating wetland structure according to claim 1, wherein the frame comprises lengthwise extending members and laterally extending members.

5. The floating wetland structure according to claim 1, wherein the frame comprises at least one horizontally extending upper member, at least one horizontally extending lower member, and at least one vertically extending member interconnecting the upper member and lower member.

6. The floating wetland structure according to claim 5, wherein the frame comprises multiple vertically extending members interconnecting the upper member and lower member such that the submerged module is maintained below the water level by the vertically extending members.

7. The floating wetland structure according to claim 6, wherein the vertically extending members each have approximately the same length such that the submerged module is maintained in a horizontal disposition below the water level.

8. The floating wetland structure according to claim 6, wherein the vertically extending members have different lengths such that the submerged module is maintained in a sloped disposition below the water level.

9. The floating wetland structure according to claim 1, wherein at least one module of the plurality of modules comprises multiple layers of buoyant panel material.

10. The floating wetland structure according to claim 1, wherein the at least one surface module has an upper surface with holes for placing plants.

11. The floating wetland structure according to claim 1, wherein the plurality of modules comprises multiple surface modules and multiple submerged modules, and defines multiple open water areas.

12. The floating wetland structure according to claim 11, wherein a riparian edge of the multiple surface modules is higher than a close-packed arrangement without open water areas.

13. The floating wetland structure according to claim 1, wherein a biofilm is supported by the submerged module.

14. A floating wetland structure according to claim 1, wherein plant life is supported by the surface module.
